(19) United States
(12) Patent Application Publication
(10) Pub. No.: US 2018/0257524 A1
(43) Pub. Date: Sep. 13, 2018

(54) Heating Device For A Seat Heater Of A Motor Vehicle

(71) Applicant: Kongsberg Automotive AB, Mullsjo (SE)

(72) Inventor: Milan Tüskes, München (DE)

(73) Assignee: Kongsberg Automotive AB, Mullsjo (SE)

(21) Appl. No.: 15/981,242

(22) Filed: May 16, 2018

Related U.S. Application Data
(63) Continuation-in-part of application No. 14/947,587, filed on Nov. 20, 2015.

(30) Foreign Application Priority Data
Nov. 21, 2014 (DE) 202014105623.8

(51) Int. Cl. B60N 2/56; H05B 3/34

(52) U.S. Cl. CPC B60N 2/5678; H05B 2203/029; H05B 3/34

(57) ABSTRACT

One embodiment of a heating device for a seat heater of a motor vehicle includes a heating device adapted to be placeable between a base body of foam and a seat cover of a vehicle seat. The heating device includes a heating mat having a carrier layer which includes a first surface and a second surface opposite the first surface. The second surface carries a heating conductor for generating heat, and the heating conductor extends over a heating area. The heating device further includes a seat cover upholstery, which can be a foam layer. The second surface of the carrier layer faces the seat cover upholstery, and the first surface of the carrier layer is adapted to face the seat cover and be in direct contact with the seat cover. The heating mat is adapted to be sewable by stitches going through the seat cover, the heating mat, and the seat cover upholstery to form seams extending through the heating area.

### CROSS-REFERENCE TO RELATED APPLICATIONS

This application is a continuation-in-part of U.S. application Ser. No. 14/947,587, filed on Nov. 20, 2015, which is the National Stage of German Patent Application No. 20 2014 105 623.8, filed on Nov. 21, 2014, the content of all of which is incorporated herein by reference.

### TECHNICAL FIELD

The present invention is directed to a heating device for a seat heater of a motor vehicle, which heating device is adapted to be placeable between a base body of foam and a seat cover of a vehicle seat, and which heating device comprises a heating mat having a carrier layer which carries a heating conductor extending over a heating area, and a foam layer as a seat cover upholstery, which seat cover upholstery is connected to the heating mat surface that carries the heating conductor.

### BACKGROUND OF THE DISCLOSURE

Motor vehicle seats comprise a seat body and a backrest connected thereto. Each of these includes a base body of foam including a carrier frame and a base body of cushioning material surrounding the carrier frame. On the outside the base body of foam is surrounded by a seat cover made of textile or leather. In the seating area (which in connection with the present application also includes a surface portion of the backrest which is in contact with the back of a person sitting on the motor vehicle seat) a heating device is disposed between the base body of foam and the seat cover in each of the seat body and the backrest. Such heating device is a compound including a heating mat, which heating mat carries a heating conductor running back and forth thereon, for example a heating conductor extending in a meandering pattern, or several parallel heating conductors, and a seat cover upholstery which according to the prior art is located directly underneath the seat cover and which is intended to improve the seating comfort.

A portion of a vehicle seat according to the prior art is shown in FIG. 1 in cross-section. On the foam base body 2 the heating device is located in the seating area, which heating device comprises a heating mat 6 and a foam layer as a seat cover upholstery 4. On the side of the heating mat 6 facing the seat over upholstery 4 a heating conductor is laid which is connected to the heating mat 6. The heating conductor may extend running forth and back or may comprise a plurality of parallel individual conductors in order to achieve a coverage of the seating area as uniform as possible, to thereby achieve heating power distributed as uniformly as possible over the seating area.

The seat cover upholstery 4 consists of a soft foam material and is intended to improve seating comfort. This seat cover upholstery is located directly underneath the outer material of the seat cover 8 made of textile or leather, in order to influence the seat feeling directly at the outer material of the seat cover. It is a disadvantage of this design that the heat generated by the heating conductor first has to pass the seat cover upholstery 4 in order to be conducted to the seat cover 8. Since heat transfer through a foam layer by heat conduction and convection has a low level of efficiency, the level of efficiency of the heating device is poor.

One embodiment of a heating device for a motor vehicle seat heating is arranged in such a manner that at a given level of heating power generated by the heating conductor an increased effective heating power available at the seat cover surface is achieved.

### SUMMARY OF THE DISCLOSURE

One embodiment of the heating device comprises a heating mat adapted to be in direct contact with the seat cover, to be sewable to the seat cover by stitches going though the seat cover, the heating mat and the seat cover upholstery to form seams extending over the heating area, by forming the heating conductor as a stranded conductor comprising at least 100 metal filaments. Due to the location of the heating mat directly underneath the seat cover and due to the sewing up forming seams extending over the heating area, a particular intimate contact of heating mat and seat cover is achieved, in particular in the seating area, which results in a substantially improved heat conduction from the heating conductor to the seat cover. It turned out that sewing up with seams running along the seating area of the heating mat (and thus crossing the heating conductor) is possible without damages of the heating conductor that could affect its performance, if the heating conductor is formed as a stranded conductor comprising at least 100 metal filaments. Even if, when forming the seams in the heating area, the heating conductor is directly struck by a needle forming the seam, the vast majority of the individual filaments of the heating conductor are displaced in lateral direction by the piercing needle, and only few individual metal filaments are damaged or severed. On the other hand the vast majority of the metallic filaments of the stranded conductor remain undamaged such that the performance of the heating conductor is not affected. This also permits that the seating area can be structured by a pattern of a plurality of seams lying close together, to thereby achieve a uniform, intimate contact of heating mat and seat cover by a fine mesh of seams extending over the seating area.

By arranging the heating conductor as a stranded conductor with more as 100 metal filaments it is also made possible that the heating device according to the invention can be sewn up in the heating area by stitches lying closely together to form tight seams, to thereby form a close and intimate contact between seat cover and heating mat.

In one embodiment the heating conductor is formed as a stranded conductor with more than 300 metal filaments. In a particularly preferred embodiment the heating conduct has a stranded conductor with more than 500 metal filaments.

In one embodiment the carrier layer of the heating mat is arranged to be air permeable to allow venting of the seat surface by a ventilator located in the motor vehicle seat. In order to ensure air permeability the carrier layer may consists of reticulated foam or may be provided with perforations.

One embodiment of a motor vehicle seat comprises a base body of foam, an outer seat cover and a heating device. The heating device is located between the seat cover and the base body of foam, wherein the heating mat of the heating device is in direct contact with the seat cover and the seating area is provided with a plurality of seams running along the heating area, wherein stitches of the seams extend through the seat cover and the seating device, such the seating area is structured by a pattern of seams and such that an intimate contact between heating mat and seat cover is formed.

### BRIEF DESCRIPTION OF THE DRAWINGS

Embodiments of the heating device will now be described with reference to the drawings in which:

FIG. 1 is a partial view of a motor vehicle seat in cross-section including a heating device according to the prior art;

FIG. 2A is a perspective view of a motor vehicle seat including having a seat cover, a heating device, and a pattern of seams for attaching the heating device to the seat cover;

FIG. 2B is an enlarged view of the seat cover and seams of FIG. 2A;

FIG. 3A is a partial cross-sectional view of a motor vehicle seat of FIG. 2A, as taken along line 3A-3A, illustrating the motor vehicle seat including a heating device according to an embodiment of the invention;

FIG. 3B is a partial cross-sectional view of a motor vehicle seat of FIG. 2A, as taken along line 3B-3B;

FIG. 4A is a lower perspective exploded view of a portion of the motor vehicle seat of FIG. 2A;

FIG. 4B is an upper perspective exploded view of a portion of the motor vehicle seat of FIG. 2A; and

FIG. 5 is an enlarged partial view of a heating conductor of one embodiment of the heating device.

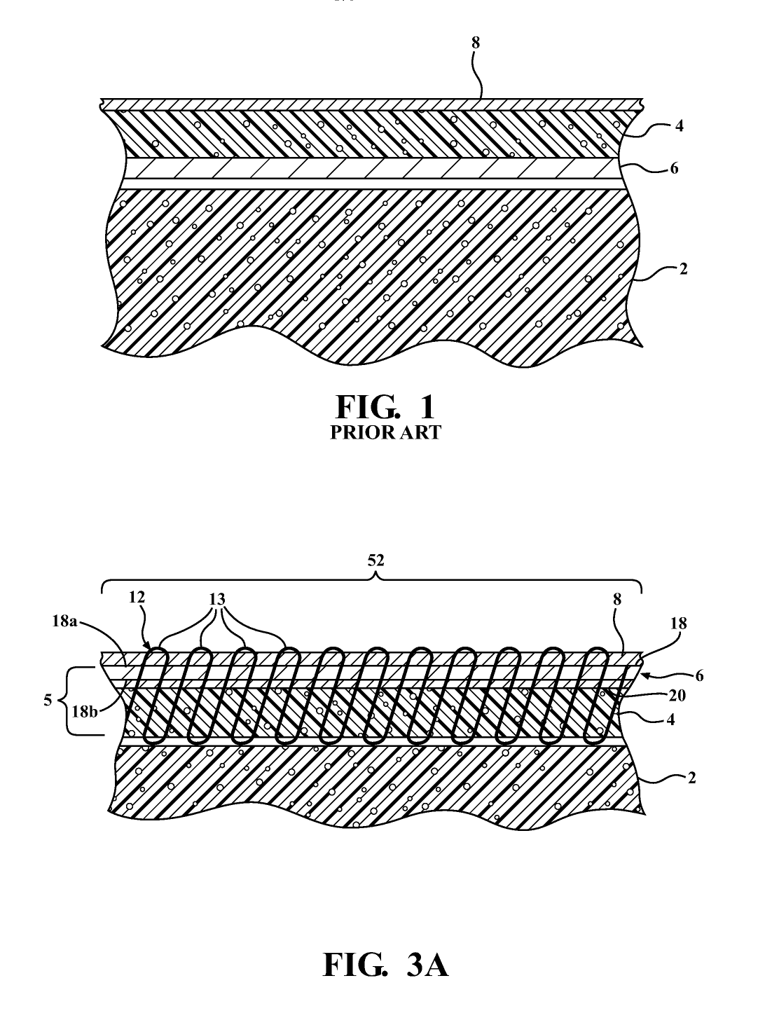

### DETAILED DESCRIPTION

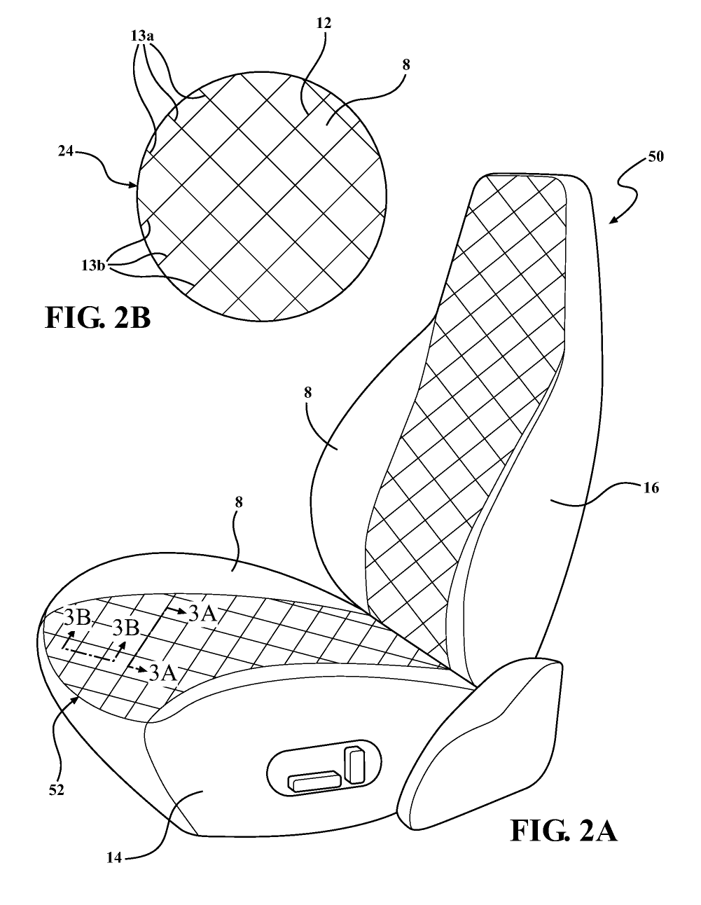

FIGS. 2A and 2B show a perspective view of a motor vehicle seat 50 having a seat bottom 14 and a seat back 16, with each of the seat bottom 14 and the seat back 16 having a seat cover 8. In this embodiment, the motor vehicle seat 50 further includes a plurality of seams 12 which include a plurality of parallel first seams 13a and a second plurality of parallel seams 13b angularly displaced at an angle with respect to the first seams 13a to form a diamond pattern 24. However, it is contemplated that the seams 12 may not intersect one another and/or the seams may be non-linear, such as a series of concentric seams or undulating seams. As described in detail below, the dense pattern of seams 12 can hold the seat cover 8 and a heating device 5 closely against one another in a heating area 52 to increase the amount of heat transferred from the heating device 5 to the seat cover 8 and a passenger seated on the seat cover 8.

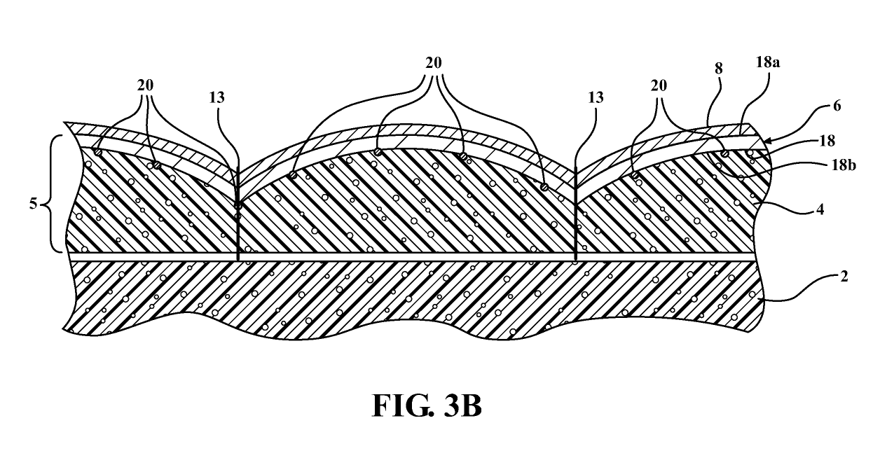

FIGS. 3A and 3B illustrate partial views of the motor vehicle seat 50 in cross-section, with the seat 50 including the heating area 52 and the heating device 5 extending over the heating area 52. The heating device 5 includes a seat cover upholstery 4 made of foam. It is contemplated that the seat cover upholstery may be formed from other suitable materials. The heating device 5 further includes a heating mat 6. The heating mat 6 includes a carrier layer 18 having a first surface 18a facing the seat cover 8 such that the first surface is directed toward a passenger seated on the seat cover 8. The carrier layer 18 further includes a second surface 18b, which is opposite to the first surface 18a and faces the seat cover upholstery 4, such that the second surface 18b faces away from a passenger seated on the seat cover 8.

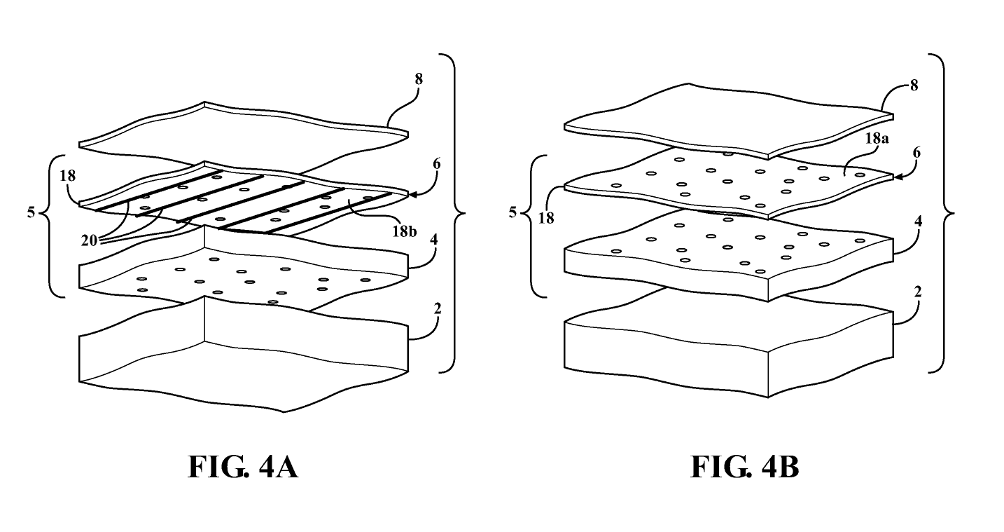

As best shown in FIGS. 4A and 4B, the heating mat 6 carries on its second surface 18b facing the seat cover upholstery 4 a heating conductor 20. The heating conductor 20 is connected to the carrier layer 18 by gluing or stitching. In this embodiment, the first surface 18a of the carrier layer 18, which faces the seat cover 8, is free of the heating conductor 20. However, in other embodiments, the heating conductor may be carried on the first surface or both the first and second surfaces of the carrier layer. The carrier layer of the heating mat may consist of felt, fleece, woven material or cut foam.

As shown in FIG. 3A, the stitches 13 of the seam 12 are applied such that they pierce through the seat cover 8, the heating mat 6, and the seat cover upholstery 4.

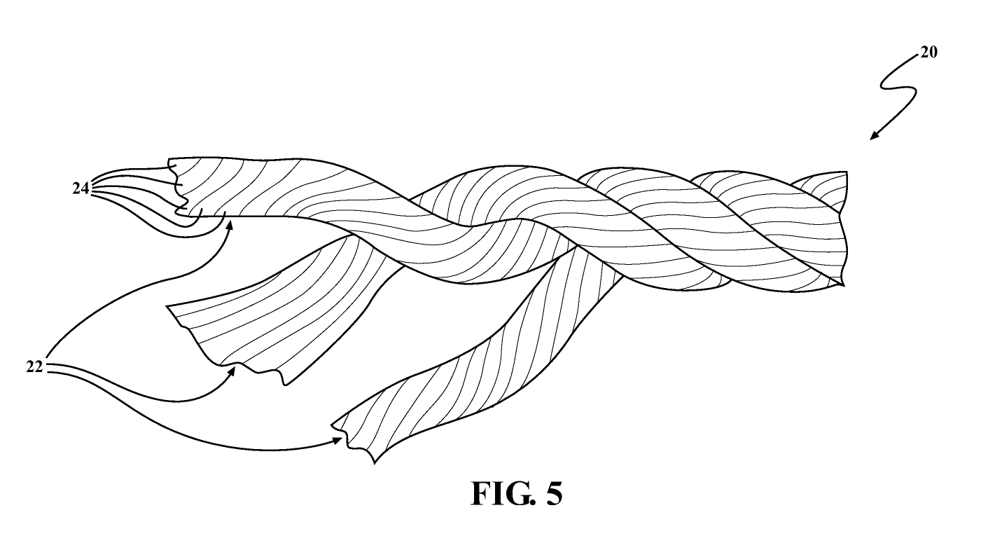

As shown in FIG. 5, the heating conductor 20 is formed as a stranded conductor 22 comprising a plurality of individual filaments 24, for example stainless steel filaments. The heating conductor 20 may also consist of several stranded conductors 22 which themselves are stranded with each other. In any case the heating conductor 20 has at least 100 individual metal filaments 24. The diameter of the individual filaments 24 is within the range from 100 nm to 100 μm. With the heating conductor 20 formed in this manner by a plurality of individual elements it is possible to apply seams 12 to the heating area, with seams crossing the extension of the heating conductor 20, without causing damages to the heating conductor 20 by the sewing process which could affect the performance of the heating conductor 20. It turned out that, if a needle hits a heating conductor 20 directly, the vast majority of the individual filaments 24 of the heating conductor 20 is displaced or pushed aside, and that damages can only occur for a few individual filaments 24. If a few individual filaments 24 are damaged the performance of the heating conductor 20 as whole is not reduced.

For this reason it is possible for a motor vehicle seat in which between base body of foam and seat cover a heating device 5 according to the present invention is placed, to provide the heating area with a dense pattern of seams 12, as is for example the diamond pattern illustrated in FIG. 2B. In this manner a close and intimate contact of seat cover and heating mat may be achieved in the entire heating area. It was found that by the seams in the heating area the heating power at the surface of the seat cover is almost doubled compared to the situation in which seams are extending only outside of the heating area.

Because the first surface 18a of the heating mat 6 is in direct contact with the seat cover 8 and the heating conductor 20 comprises a sufficient number of individual filaments 22 that remain unbroken when the heating conductor 20 is directly hit by a needle when the seams 12 are formed, a substantially improved efficiency of the heating device 5 is achieved.

The invention has been described in an illustrative manner, and it is to be understood that the terminology which has been used is intended to be in the nature of words of description rather than of limitation. As is now apparent to those skilled in the art, many modifications and variations of the subject invention are possible in light of the above teachings. It is, therefore, to be understood that within the scope of the appended claims, wherein reference numerals are merely for convenience and are not to be in any way limiting, the invention may be practiced otherwise than as specifically described.

1. A heating device for a seat heater of a motor vehicle, said heating device adapted to be placeable between a base body of foam and a seat cover of a vehicle seat, and said heating device comprising:
a heating mat having a carrier layer which comprises a first surface and a second surface opposite said first surface, said second surface carrying a heating conductor for generating heat, and said heating conductor extending over a heating area; and
a seat cover upholstery comprising a foam layer;
wherein said second surface of said carrier layer faces said seat cover upholstery and said first surface of said carrier layer is adapted to face the seat cover and be in direct contact with the seat cover; and
wherein said heating mat is adapted to be sewable by stitches going through the seat cover, said heating mat, and the seat cover upholstery to form seams extending through said heating area.

2. The heating device according to claim 1, wherein said heating conductor is a stranded conductor comprising at least 300 metal filaments.

3. The heating device according to claim 1, wherein said heating conductor is a stranded conductor comprising at least 500 metal filaments.

4. The heating device according to claim 1, wherein said carrier layer of said heating mat consists of felt, fleece, woven material or cut foam.

5. The heating device according to claim 1, wherein said carrier layer of said heating mat is arranged to be air permeable.

6. The heating device according to claim 5, wherein said carrier layer of said heating mat is formed of reticulated foam or is provided with perforations in order to ensure air permeability.

7. (canceled)

8. The heating device according to claim 1, wherein said heating conductor is a stranded conductor comprising at least 200 metal filaments.

9. The heating device according to claim 1, wherein each of said metal filaments has a diameter of from 100 nm to 100 μm.

10. Motor A motor vehicle seat comprising:
a base body of foam;
a seat cover; and
a heating device disposed between said base body of foam and said seat cover, said heating device comprising;
a heating mat having a carrier layer which comprises a first surface and a second surface opposite said first surface, said second surface carrying a heating conductor for generating heat, and said heating conductor extending over a heating area; and
a seat cover upholstery comprising a foam layer;
wherein said second surface of said carrier layer faces said seat cover upholstery, and said first surface of said carrier layer faces said seat cover and is in direct contact with the seat cover; and
wherein said heating mat is sewn by stitches going through said seat cover, said heating mat, and said seat cover upholstery to form seams extending through said heating area.

11. The motor vehicle seat according to claim 10, wherein said heating conductor is a stranded conductor comprising at least 200 metal filaments.

12. The motor vehicle seat according to claim 10, wherein each of said metal filaments has a diameter of from 100 nm to 100 μm.

13. The motor vehicle seat according to claim 10, comprising a plurality of parallel first seams and, at an angle with respect to the first seams, a second plurality of parallel seams which together form a diamond pattern on said seat cover.

14. The heating device according to claim 1, wherein said heating conductor is a stranded conductor comprising at least 100 metal filaments.

15. The motor vehicle seat according to claim 10, wherein said heating conductor is a stranded conductor comprising at least 100 metal filaments.
